(19) United States
(12) Patent Application Publication
(10) Pub. No.: US 2015/0255208 A1
(43) Pub. Date: Sep. 10, 2015

(54) CHIP ELECTRONIC COMPONENT AND MANUFACTURING METHOD THEREOF

(71) Applicant: SAMSUNG ELECTRO-MECHANICS CO., LTD., Suwon-Si (KR)

(72) Inventors: Go Eun KIM, Suwon-Si (KR); Hwa Sung HWANG, Suwon-Si (KR); Dobashi MAKOTO, Suwon-Si (KR)

(21) Appl. No.: 14/296,074

(22) Filed: Jun. 4, 2014

(30) Foreign Application Priority Data
Mar. 10, 2014 (KR) 10-2014-0027766

(51) Int. Cl. H01F 27/34; H01F 41/04; H01F 27/28

(52) U.S. Cl. CPC H01F 27/343; H01F 27/2804; H01F 41/04; H01F 2027/2809

(57) ABSTRACT

A chip electronic component may include an internal coil structure for preventing the occurrence of short-circuits between coil patterns and may have a high aspect ratio (AR) by increasing a thickness of the coil with respect to a width of the coil. The chip electronic component may include a magnetic body including an insulating substrate; an internal coil part formed on at least one surface of the insulating substrate; external electrodes formed on at least one end surface of the magnetic body and connected to the internal coil part. Insoluble films may be formed on side portions of coil patterns forming the internal coil part, and the internal coil part may have an aspect ratio of 1.5 or greater.

### CROSS-REFERENCE TO RELATED APPLICATION

This application claims the benefit of Korean Patent Application No. 10-2014-0027766 filed on Mar. 10, 2014, with the Korean Intellectual Property Office, the disclosure of which is incorporated herein by reference.

### BACKGROUND

The present disclosure relates to a chip electronic component and a manufacturing method thereof.

An inductor, which is one of chip electronic components, is a representative passive element configuring an electronic circuit together with a resistor and a capacitor to remove a noise. The inductor is combined with the capacitor using electromagnetic properties to configure a resonance circuit amplifying a signal in a specific frequency band, a filter circuit, or the like.

Recently, as miniaturization and thinness of information technology (IT) devices such as various communications devices, display devices, or the like, have been accelerated, research into a technology for miniaturizing and thinning various elements such as an inductor, a capacitor, a transistor, and the like, used in these ID devices has been continuously conducted. The inductor has also been rapidly replaced by a chip having a small size and a high density and capable of being automatically surface-mounted, and a thin film inductor in which a mixture of a magnetic powder and a resin is formed on a coil pattern formed on upper and lower surfaces of a thin film insulating substrate by plating has been developed.

A direct current (DC) resistance Rdc, which is one of the main characteristics of the inductor, is decreased as a cross-sectional area of a coil is increased. Therefore, in order to decrease the DC resistance Rdc and increase an inductance value, it is required to increase a cross-sectional area of an internal coil.

There are two methods of increasing the cross-sectional area of the coil. One is to increase a width of the coil and the other one is to increase a thickness of the coil.

In the case of increasing the width of the coil, a risk that a short-circuit will occur between the coils is significantly increased, and the number of turns in an inductor chip may be decreased, which leads to a decrease in an area occupied by a magnetic part, whereby product efficiency is decreased, and there is a limitation in implementing high capacitance in the product.

Therefore, the internal coil of the thin film-type inductor is required to have a structure in which a high aspect ratio (AR) is obtained through increasing the thickness of the internal coil. The aspect ratio AR of the internal coil is obtained by dividing the thickness of the internal coil by the width thereof. In order to obtain a high aspect ratio AR, growth of the internal coil in a width direction should be suppressed, and growth of the internal coil in a thickness direction should be promoted.

According to the related art, in order to form a relatively thick coil by performing a pattern plating method using a plating resist, the plating resist should be formed to have a predetermined width or greater, in order to maintain a form thereof, resulting in an increase in an interval between coil pattern portions.

In addition, according to the related art electroplating process, while the plating is performed, isotropic growth of the coil in both of a thickness direction and a width direction is implemented, whereby short circuits may occur between the coil portions and it may be difficult for the coil to have a sufficiently high aspect ratio (AR).

### RELATED ART DOCUMENT

### (Patent Document 1) Japanese Patent Laid-Open Publication No. 2006-278479

### SUMMARY

An aspect of the present disclosure may provide a chip electronic component having an internal coil structure preventing occurrence of short-circuits between coil portions and having a high aspect ratio (AR) by increasing a thickness of the coil with respect to a width of the coil, and a manufacturing method thereof.

According to an aspect of the present disclosure, a chip electronic component may include: a magnetic body including an insulating substrate; an internal coil part formed on at least one surface of the insulating substrate; external electrodes formed on at least one end surface of the magnetic body and connected to the internal coil part, wherein insoluble films may be formed on side portions of coil patterns forming the internal coil part, and the internal coil part may have an aspect ratio of 1.5 or greater.

The insoluble films may be formed on side portions of central coil patterns among the coil patterns forming the internal coil part.

The insoluble films may be formed on inner side portions of an outermost coil pattern and an innermost coil pattern among the coil patterns forming the internal coil part.

The insoluble films may include at least one selected from a group consisting of a tetrazole based compound, a triazole based compound, and an imidazole based compound.

The internal coil part may include first coil pattern portions formed on the insulating substrate, second coil pattern portions coating the first coil pattern portions, and third coil pattern portions formed on the second coil pattern portions.

The insoluble films may be formed on side portions of the second coil pattern portions.

The second coil pattern portions may be grown in a width direction and a thickness direction, and the third coil pattern portions may only be grown in the thickness direction.

The second coil pattern portions may be formed by isotropic plating, and the third coil pattern portions may be formed by anisotropic plating.

The internal coil part may be formed of at least one selected from a group consisting of silver (Ag), palladium (Pd), aluminum (Al), nickel (Ni), titanium (Ti), gold (Au), copper (Cu), and platinum (Pt).

The chip electronic component may further include an insulating layer coating the internal coil part.

According to another aspect of the present disclosure, a method of manufacturing a chip electronic component may include: forming an internal coil part on at least one surface of an insulation substrate; stacking magnetic layers on and below the insulating substrate on which the internal coil part is formed, to thereby forma magnetic body; and forming external electrodes on at least one end surface of the magnetic body to be connected to the internal coil part, wherein the forming of the internal coil part may be conducted by forming insoluble films on side portions of coil patterns forming the internal coil part and performing electroplating.

The insoluble films may be formed on side portions of central coil patterns among the coil patterns forming the internal coil part.

The insoluble films may be formed on inner side portions of an outermost coil pattern and an innermost coil pattern among the coil patterns forming the internal coil part.

The insoluble films may include at least one selected from a group consisting of a tetrazole based compound, a triazole based compound, and an imidazole based compound.

The forming of the internal coil part may include: forming first coil pattern portions on at least one surface of the insulating substrate and performing electroplating on the first coil pattern portions to form second coil pattern portions coating the first coil pattern portions; forming the insoluble films coating the second coil pattern portions; removing portions of the insoluble films formed in regions except for the side portions of the second coil pattern portions; and performing electroplating on the second coil pattern portions from which the insoluble films are partially removed to thereby form third coil pattern portions.

The second coil pattern portions may be formed by isotropic plating, and the third coil pattern portions may be formed by anisotropic plating.

The internal coil part may be formed to have an aspect ratio of 1.5 or greater.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view illustrating an internal coil part within a chip electronic component according to an exemplary embodiment of the present disclosure;

FIG. 2 is a cross-sectional view taken along line I-I′ of FIG. 1;

FIG. 3 is an enlarged view of part A of FIG. 2;

FIG. 4 is an enlarged cross-sectional view illustrating a portion of an internal coil part of a chip electronic component according to an exemplary embodiment of the present disclosure;

FIG. 5 is a flowchart illustrating a method of manufacturing a chip electronic component according to an exemplary embodiment of the present disclosure; and

FIGS. 6 through 9 are views illustrating sequential processes in a method of manufacturing a chip electronic component according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Chip Electronic Component

Hereinafter, a chip electronic component according to an exemplary embodiment of the present disclosure, particularly, a thin film inductor will be described. However, the present disclosure is not limited thereto.

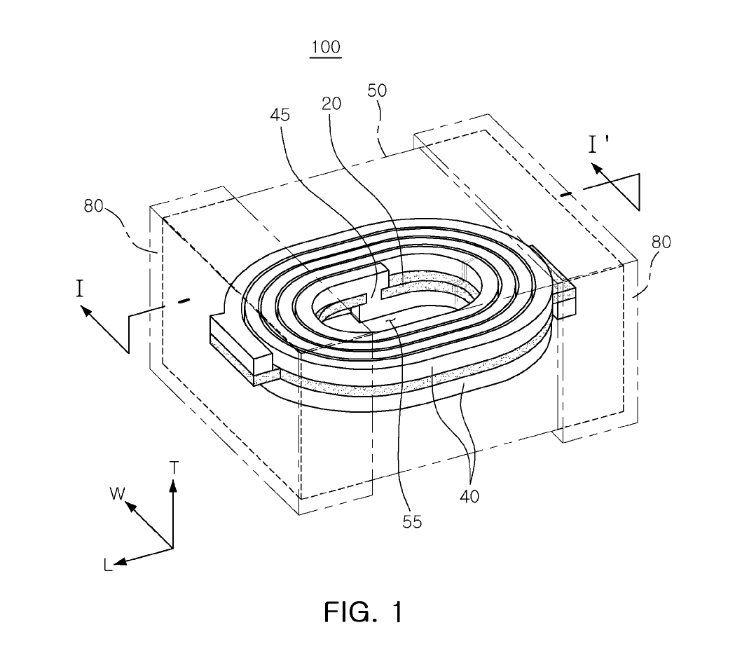

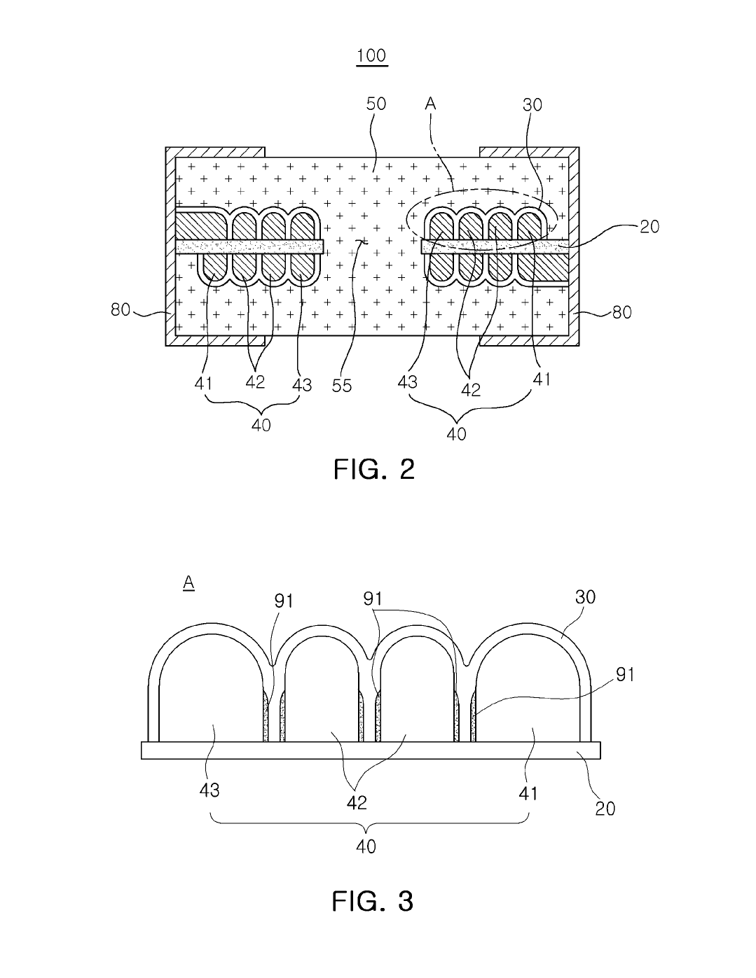

FIG. 1 is a schematic perspective view illustrating an internal coil part within a chip electronic component according to an exemplary embodiment of the present disclosure; FIG. 2 is a cross-sectional view taken along line I-I′ of FIG. 1; and FIG. 3 is an enlarged view of part A of FIG. 2.

Referring to FIGS. 1 and 2, a thin-film-type chip inductor 100 used in a power line of a power supply circuit is disclosed as an example of a chip electronic component. A chip bead, a chip filter, and the like, as well as the chip inductor may be appropriately used as the chip electronic component.

The thin film inductor 100 may include a magnetic body 50, an insulating substrate 20, an internal coil part 40, and external electrodes 80.

The magnetic body 50 may form an exterior appearance of the thin film inductor 100 and may be formed of any material that exhibits magnetic properties. For example, the magnetic body 50 may be formed by filling ferrite or a metal based soft magnetic material.

The ferrite may be ferrite known in the art such as Mn—Zn based ferrite, Ni—Zn based ferrite, Ni—Zn—Cu based ferrite, Mn—Mg based ferrite, Ba based ferrite, Li based ferrite, or the like.

The metal based soft magnetic material may be an alloy containing at least one selected from a group consisting of Fe, Si, Cr, Al, and Ni. For example, the metal based soft magnetic material may contain Fe—Si—B—Cr based amorphous metal particles, but is not limited thereto.

The metal based soft magnetic material may have a particle diameter of 0.1 μm to 20 μm, and may be dispersed in a polymer such as an epoxy resin, a polyimide, or the like.

The magnetic body 50 may have a hexahedral shape. Directions of a hexahedron will be defined in order to clearly describe an exemplary embodiment of the present disclosure. L, W and T of a hexahedron shown in FIG. 1 refer to a length direction, a width direction, and a thickness direction, respectively. The magnetic body 50 may have a rectangular parallelepiped shape in which a length thereof in the length direction is greater than a length thereof in the width direction.

The insulating substrate 20 formed in the magnetic body 50 may be, for example, a polypropylene glycol (PPG) substrate, a ferrite substrate, a metal based soft magnetic substrate, or the like.

The insulating substrate 20 may have a through hole formed in a central portion thereof, wherein the through hole may be filled with a magnetic material such as a ferrite, a metal based soft magnetic material, or the like, to form a core part 55. The core part 55 may be filled with the magnetic material, thereby increasing inductance L.

The internal coil part 40 may be formed on one surface and the other surface of the insulating substrate 20, respectively, wherein the internal coil part 40 may have a coil shaped pattern.

The internal coil part 40 may include a spiral shaped coil pattern, and the internal coil part 40 formed on one surface of the insulating substrate 20 may be electrically connected to that formed on the other surface of the insulating substrate 20 through a via electrode 45 formed in the insulating substrate 20.

Referring to FIG. 3, insoluble films 91 may be formed on side portions of coil patterns forming the internal coil part 40.

The insoluble films 91 may be formed on side portions of central coil patterns 42 among the coil patterns forming the internal coil part 40. In addition, the insoluble films 91 may also be formed on inner side portions of the outermost coil pattern 41 and the innermost coil pattern 43.

As described above, the insoluble films 91 formed on the side portions of the coil patterns may promote growth of the coil in a thickness direction and suppress growth of the coil in a width direction, whereby the occurrence of short-circuits between the coil patterns may be prevented and the internal coil part 40 may have a high aspect ratio (AR). For example, the internal coil part 40 may have an aspect ratio (AR) (T/W) of 1.5 or greater.

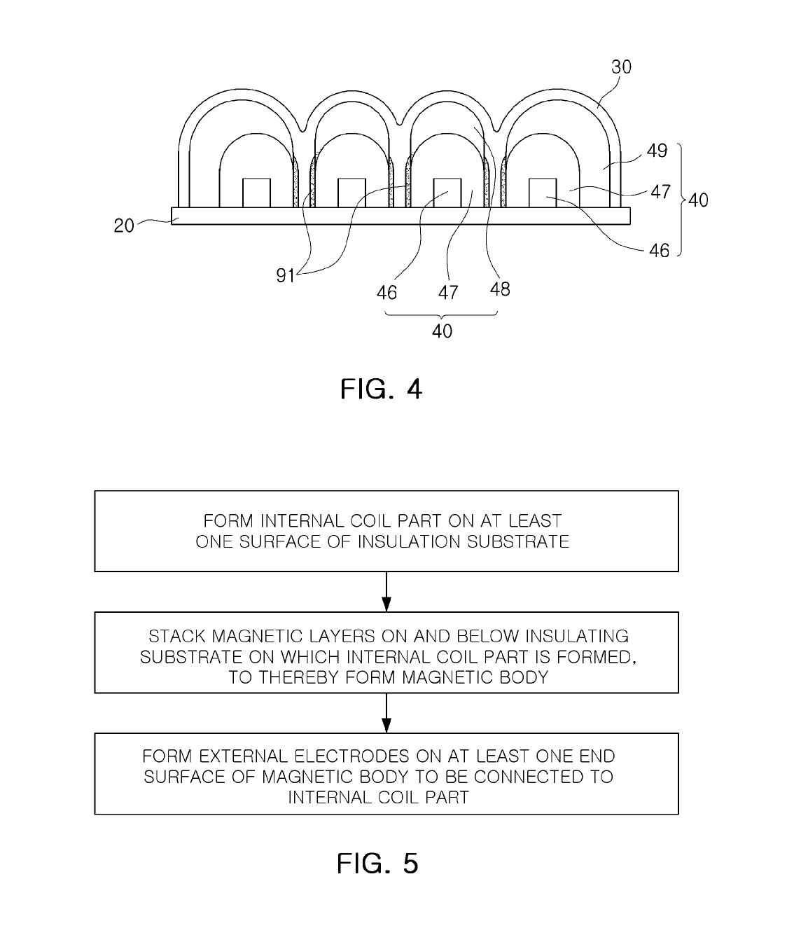

FIG. 4 is an enlarged cross-sectional view of an internal coil part in a chip electronic component according to an exemplary embodiment of the present disclosure.

Referring to FIG. 4, the internal coil part 40 may include first coil pattern portions 46 formed on the insulating substrate 20, second coil pattern portions 47 coating the first coil pattern portions 46, and third coil pattern portions 48 and 49 formed on the second coil pattern portions 47.

The first coil pattern portion 46 may be a pattern plating layer formed by disposing a patterned plating resist on the insulating substrate 20 and filling openings with a conductive metal.

The second coil pattern portion 47 may be formed by electroplating and may be formed of an isotropic plating layer which is grown in both of a width direction W and a thickness direction T.

After the insoluble films 91 are formed to entirely cover the second coil pattern portion 47, the insoluble films 91 formed in regions except for side portions of the second coil pattern portions 47 may be removed by an inching method, or the like, such that the insoluble films 91 may only be formed on the side portions of the second coil pattern portions 47.

Electroplating may be performed on the side portions of the second coil pattern portions 47 on which the insoluble films 91 are formed to thereby form the third coil pattern portions 48. The third coil pattern portion 48 may be formed of an anisotropic plating layer which is only grown in the thickness direction T while being suppressed from being grown in the width direction W by the insoluble films 91 formed on the side portions of the second coil pattern portions 47.

Meanwhile, although the insoluble films 91 are formed on the entirety of the side portions of the central coil patterns 42, they may only be formed on the inner side portions of the outermost coil pattern 41 and the innermost coil pattern 43, such that the third coil pattern portions 49 of the outermost coil pattern 41 and the innermost coil pattern 43 may be formed of an isotropic plating layer which is grown in both of the width direction W and the thickness direction T.

The internal coil part 40 may be formed of a metal having excellent electrical conductivity, such as silver (Ag), palladium (Pd), aluminum (Al), nickel (Ni), titanium (Ti), gold (Au), copper (Cu), or platinum (Pt), an alloy thereof, or the like.

The first coil pattern portions 46, the second coil pattern portions 47, and the third coil pattern portions 48 and 49 may be formed of the same metal, preferably, copper (Cu).

The insoluble films 91 may include at least one selected from a group consisting of a tetrazole based compound, a triazole based compound, and an imidazole based compound. For example, a benzimidazole based compound may be used.

The internal coil part 40 may be coated with an insulating layer 30.

The insulating layer 30 may be formed by a method known in the art such as a screen printing method, a method for the exposure and development of a photoresist (PR), a spraying method, or the like. The internal coil part 40 may be coated with the insulating layer 30, such that it does not directly contact the magnetic material configuring the magnetic body 50.

One end portion of the internal coil part 40 formed on one surface of the insulating substrate 20 may be exposed to one end surface of the magnetic body 50 in the length direction of the magnetic body 50, and one end portion of the internal coil part 40 formed on the other surface of the insulating substrate 20 may be exposed to the other end surface of the magnetic body 50 in the length direction of the magnetic body 50.

The external electrodes 80 may be formed on both end surfaces of the magnetic body 50 in the length direction thereof, respectively, so as to be connected to the internal coil part 40 exposed to the end surfaces of the magnetic body 50 in the length direction thereof. The external electrodes 80 may be extended to both end surfaces of the magnetic body 50 in the thickness direction thereof and/or both end surfaces of the magnetic body 50 in the width direction thereof.

The external electrodes 80 may be formed of a metal having excellent electrical conductivity, for example, nickel (Ni), copper (Cu), tin (Sn), silver (Ag) or an alloy thereof.

### Method of Manufacturing Chip Electronic Component

FIG. 5 is a flowchart illustrating a method of manufacturing a chip electronic component according to an exemplary embodiment of the present disclosure; and FIGS. 6 through 9 are views illustrating sequential processes in the method of manufacturing a chip electronic component according to an exemplary embodiment of the present disclosure.

Referring to FIG. 5, the internal coil part 40 may be formed on at least one surface of the insulation substrate 20.

The insulating substrate 20 is not particularly limited, but may be, for example, a polypropylene glycol (PPG) substrate, a ferrite substrate, a metal based soft magnetic substrate, or the like, and may have a thickness of 40 μm to 100 μm.

A method of forming the internal coil part 40 will be described below. Referring to FIG. 6, the first coil pattern portions 46 may be formed on the insulating substrate 20, and the second coil pattern portions 47 may be formed to coat the first coil pattern portions 46.

The first coil pattern portions 46 may be formed by disposing a plating resist having openings on the insulating substrate 20, filling the openings with an electrically conductive metal by an electroplating process, or the like, and removing the plating resist by a chemical etching process, or the like.

The plating resist may be a general photosensitive resist film, such as a dry film resist, or the like, but is not limited thereto.

The second coil pattern portions 47 may be formed by performing electroplating on the first coil pattern portions 46. By adjusting a current density, a concentration of a plating solution, a plating speed, and the like at the time of performing the electroplating, the second coil pattern portions 47 may be formed of an isotropic plating layer which is grown in both of the width direction W and the thickness direction T.

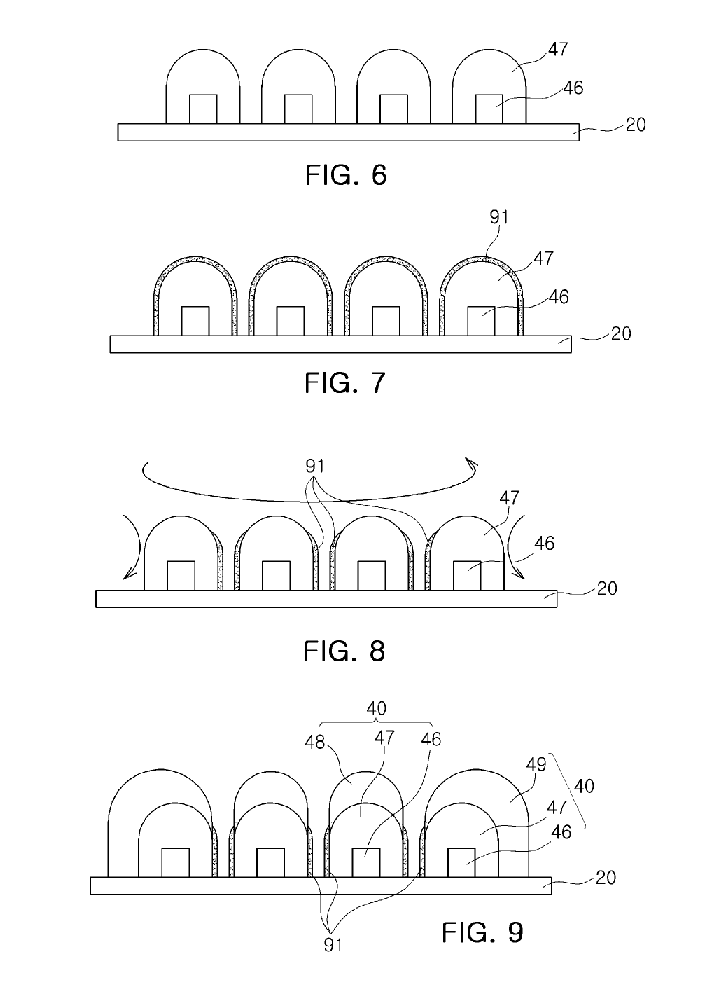

Referring to FIG. 7, the insoluble films 91 may be formed to entirely cover the second coil pattern portions 47.

The insoluble films 91 may be formed by immersing the second coil pattern portions 47 in a solution containing at least one selected from a group consisting of a tetrazole based compound, a triazole based compound, and an imidazole based compound, for example, a benzimidazole based compound.

Referring to FIG. 8, portions of the insoluble films 91 formed in the regions except for the side portions of the second coil pattern portions 47 among the insoluble films 91 coating the second coil pattern portions 47 may be removed.

The insoluble films 91 may be removed by an inching method, or the like, and portions thereof to which large physical force is applied may be removed.

The portions of the insoluble films 91 may be removed as described above, and the insoluble films may remain on the side portions of the central coil patterns 42 among the coil patterns forming the internal coil part 40 and on the inner side portions of the outermost coil pattern 41 and the innermost coil pattern 43 among the coil patterns forming the internal coil part 40.

Referring to FIG. 9, electroplating may be performed on the side portions of the second coil pattern portions 47 on which the insoluble films 91 remain after being partially removed, thereby forming the third coil pattern portions 48 and 49.

The third coil pattern portion 48 may be formed of an anisotropic plating layer which is only grown in the thickness direction T while being suppressed from being grown in the width direction W by the insoluble films 91 formed on the side portions of the second coil pattern portions 47.

Meanwhile, although the insoluble films 91 are formed on the entirety of the side portions of the central coil patterns 42, they may only be formed on the inner side portions of the outermost coil pattern 41 and the innermost coil pattern 43, such that the third coil pattern portions 49 of the outermost coil pattern 41 and the innermost coil pattern 43 may be formed of an isotropic plating layer which is grown in both of the width direction W and the thickness direction T.

The internal coil part 40 including the first coil pattern portions 46, the second coil pattern portions 47, and the third coil pattern portions 48 and 49 may be formed of a metal having excellent electrical conductivity, such as silver (Ag), palladium (Pd), aluminum (Al), nickel (Ni), titanium (Ti), gold (Au), copper (Cu), or platinum (Pt), an alloy thereof, or the like.

The first coil pattern portions 46, the second coil pattern portions 47, and the third coil pattern portions 48 and 49 may be formed of the same metal, preferably, copper (Cu).

As described above, the insoluble films 91 are formed on the side portions of the coil pattern portions and the electroplating process is performed to promote the growth of the coil in the thickness direction and suppress the growth of the coil in the width direction, whereby the occurrence of short-circuits between the coil patterns may be prevented and the internal coil part 40 may have a high aspect ratio (AR). For example, the internal coil part 40 may have an aspect ratio (AR) (T/W) of 1.5 or greater.

The via electrode 45 may be formed by forming a hole in a portion of the insulation substrate 20 and filling the hole with a conductive material, and the coil patterns of the internal coil part 40 formed on one surface and the other surface of the insulation substrate 20 may be electrically connected to each other through the via electrode 45.

The hole penetrating through the insulating substrate 20 may be formed in a central portion of the insulating substrate 20 by performing a drilling process, a laser process, a sand blast process, or a punching process, or the like.

After the internal coil part 40 is formed, the insulating layer 30 coating the internal coil part 40 may be formed. The insulating layer 30 may be formed by a method well-known in the art such as a screen printing method, a method for the exposure and development of a photoresist (PR), a spraying method, or the like, but is not limited thereto.

Next, magnetic layers may be stacked on and below the insulating substrate 20 on which the internal coil part 40 is formed, thereby forming the magnetic body 50.

The magnetic layers may be stacked on both surfaces of the insulating substrate 20, and be compressed by a lamination method or a hydrostatic pressing method, thereby forming the magnetic body 50. In this case, the hole may be filled with the magnetic material to form the core part 55.

Next, the external electrodes 80 may be formed to be connected to the internal coil part 40 exposed to at least one end surface of the magnetic body 50.

The external electrodes 80 may be formed of a paste containing a metal having excellent electrical conductivity, for example, a conductive paste containing nickel (Ni), copper (Cu), tin (Sn), or silver (Ag), or an alloy thereof. The external electrodes 80 may be formed by a dipping method, or the like, as well as a printing method, depending on a shape thereof.

A description of features that are the same as those of the chip electronic component according to the above-described exemplary embodiment of the present disclosure will be omitted.

As set forth above, according to exemplary embodiments of the present disclosure, a chip electronic component may have an internal coil structure preventing the occurrence of short-circuits between coil patterns and having a high aspect ratio (AR) by increasing a thickness of the coil with respect to a width of the coil.

Therefore, a cross-sectional area of the coil may be increased to decrease direct current (DC) resistance (Rdc) and increase inductance.

While exemplary embodiments have been shown and described above, it will be apparent to those skilled in the art that modifications and variations could be made without departing from the spirit and scope of the present disclosure as defined by the appended claims.

What is claimed is:

1. A chip electronic component, comprising:
a magnetic body including an insulating substrate;
an internal coil part disposed on at least one surface of the insulating substrate; and
external electrodes disposed on at least one end surface of the magnetic body and connected to the internal coil part,
wherein insoluble films are disposed on side portions of coil patterns included in the internal coil part, and
the internal coil part has an aspect ratio of 1.5 or greater.

2. The chip electronic component of claim 1, wherein the insoluble films are formed on side portions of central coil patterns among the coil patterns forming the internal coil part.

3. The chip electronic component of claim 1, wherein the insoluble films are formed on inner side portions of an outermost coil pattern and an innermost coil pattern among the coil patterns forming the internal coil part.

4. The chip electronic component of claim 1, wherein the insoluble films include at least one selected from a group consisting of a tetrazole based compound, a triazole based compound, and an imidazole based compound.

5. The chip electronic component of claim 1, wherein the internal coil part includes first coil pattern portions formed on the insulating substrate, second coil pattern portions coating the first coil pattern portions, and third coil pattern portions formed on the second coil pattern portions.

6. The chip electronic component of claim 5, wherein the insoluble films are formed on side portions of the second coil pattern portions.

7. The chip electronic component of claim 5, wherein the second coil pattern portions are grown in a width direction and a thickness direction, and
the third coil pattern portions are only grown in the thickness direction.

8. The chip electronic component of claim 5, wherein the second coil pattern portions are formed by isotropic plating, and
the third coil pattern portions are formed by anisotropic plating.

9. The chip electronic component of claim 1, wherein the internal coil part is formed of at least one selected from a group consisting of silver (Ag), palladium (Pd), aluminum (Al), nickel (Ni), titanium (Ti), gold (Au), copper (Cu), and platinum (Pt).

10. The chip electronic component of claim 1, further comprising an insulating layer coating the internal coil part.

11. A method of manufacturing a chip electronic component, the method comprising:
forming an internal coil part on at least one surface of an insulation substrate;
stacking magnetic layers on and below the insulating substrate on which the internal coil part is formed, to thereby form a magnetic body; and
forming external electrodes on at least one end surface of the magnetic body to be connected to the internal coil part,
wherein the forming of the internal coil part is conducted by forming insoluble films on side portions of coil patterns forming the internal coil part and performing electroplating.

12. The method of claim 11, wherein the insoluble films are formed on side portions of central coil patterns among the coil patterns forming the internal coil part.

13. The method of claim 11, wherein the insoluble films are formed on inner side portions of an outermost coil pattern and an innermost coil pattern among the coil patterns forming the internal coil part.

14. The method of claim 11, wherein the insoluble films include at least one selected from a group consisting of a tetrazole based compound, a triazole based compound, and an imidazole based compound.

15. The method of claim 11, wherein the forming of the internal coil part includes:
forming first coil pattern portions on at least one surface of the insulating substrate and performing electroplating on the first coil pattern portions to form second coil pattern portions coating the first coil pattern portions;
forming the insoluble films coating the second coil pattern portions;
removing portions of the insoluble films formed in regions except for the side portions of the second coil pattern portions; and
performing electroplating on the second coil pattern portions from which the insoluble films are partially removed to thereby form third coil pattern portions.

16. The method of claim 15, wherein the second coil pattern portions are formed by isotropic plating, and
the third coil pattern portions are formed by anisotropic plating.

17. The method of claim 11, wherein the internal coil part is formed to have an aspect ratio of 1.5 or greater.
